(19) United States
(12) Patent Application Publication
(10) Pub. No.: US 2023/0326354 A1
(43) Pub. Date: Oct. 12, 2023

(54) METHOD AND SYSTEM FOR DETERMINING IMPROVED FLIGHT TRAJECTORY

(71) Applicant: Adam Durant, Cambridge (GB)

(72) Inventor: Adam Durant, Cambridge (GB)

(21) Appl. No.: 18/060,546

(22) Filed: Nov. 30, 2022

(30) Foreign Application Priority Data
Apr. 12, 2022 (GB) 2205368.0

(51) Int. Cl. G08G 5/00; G08G 5/04; G01W 1/02; B64D 45/00

(52) U.S. Cl. CPC G08G 5/0039; G08G 5/006; G08G 5/045; G08G 5/0091; G01W 1/02; B64D 45/00; G01W 2001/003

(57) ABSTRACT

Disclosed is method for determining improved flight trajectory 208. The method comprises receiving one or more weather parameters to determine contrail forecast data; receiving one or more flight parameters associated with at least one aircraft 204 to determine flight data thereof; receiving flight schedule comprising at least one flight plan 206 of at least one aircraft; analyzing at least one flight plan to determine at least one navigational avoidance between at least two aircraft; determining contrail likelihood associated with at least one aircraft; altering one or more flight parameters to determine improved flight trajectory for at least one flight plan; sending at least one flight plan including improved flight trajectory to at least one aircraft; and validating improved flight trajectory using imagery data, when at least one aircraft flies according to at least one flight plan including improved flight trajectory. Disclosed also is system 200 for determining improved flight trajectory.

### TECHNICAL FIELD

This invention relates to improved aircraft flight trajectories. In particular, though not exclusively, this invention relates to methods and systems for determining improved flight trajectories and minimizing contrail formation caused by aircraft. Moreover, the present disclosure relates to a computer program product for determining an improved flight trajectory.

### BACKGROUND

The global aviation industry has contributed substantially to a climate impact due to a steady increase in the number of in-service aircraft and flights. Such an increase in the flights has resulted in carbon dioxide emission (due to exhaust gases from combustion of aviation fuel), other non-carbon dioxide emissions (e.g. soot, sulphate aerosols etc.), and contrail formation during aircraft cruising. Notably, approximately 60% of the impact of aviation emissions on human-induced climate change can be attributed to contrails. Condensation trails, or contrails, are typically left behind by aircraft flying at high altitudes and are an everyday observable phenomenon. Notably, the contrails can persist for many hours, depending on characteristics of temperature, humidity, wind, and a stability of the air aloft. Aircraft contrails that persist for several hours (and those that have significant horizontal spreading across the sky) can influence the radiation balance of the atmosphere leading to a net warming influence which contributes to the global warming effect. One of the factors causing contrail formation by the aircraft is the trajectory of flight of the aircraft.

Current technological mitigation of contrail formation includes improvement in engine design (e.g. reduction in weight) and performance (i.e. efficiency), using ‘sustainable aviation fuels’ (e.g. hydrogen-based aviation fuels), changing the flight trajectories to minimize contrail formation, and so forth. However, improvement in engine design and performance may be expensive, come with an associated environmental footprint and carbon offset, and fail to effectively mitigate contrail formation. Moreover, the uncertainties associated with changing flight trajectories to minimize contrails fails to effectively mitigate the contrails and also pose a challenge in predicting their forcing on the radiation budget of the atmosphere. Historically, various computational prediction models have been developed to estimate the improved flight trajectories associated with reduced atmospheric radiative forcing due to contrail formation. However, such models have been limited by their horizontal and vertical resolution and have required large computational times in order to parameterize the physics and dynamics of contrail formation associated with different flight trajectories. More recent advancements in numerical weather prediction and simulation on high performance computer platforms has allowed for significant improvements within this domain. However, such measures also fail to provide an improved reduction in the contrail formation caused by the flights.

There remains a need for improved methods and systems that can mitigate contrail formation caused by the aircraft.

### SUMMARY

A first aspect of the invention provides a method for (namely, a method of) determining an improved flight trajectory, the method comprising:
receiving one or more weather parameters to determine a contrail forecast data;
receiving one or more flight parameters associated with at least one aircraft to determine a flight data of the at least one aircraft;
receiving a flight schedule comprising at least one flight plan of at least one aircraft, wherein the flight schedule pertains to a given period of time;
analyzing the at least one flight plan to determine at least one navigational avoidance between at least two aircraft;
determining, based on the contrail forecast data, the flight data and the at least one flight plan, a contrail likelihood associated with the at least one aircraft;
altering, based on the at least one navigational avoidance and the contrail likelihood, the one or more flight parameters of the at least one aircraft to determine an improved flight trajectory for the at least one flight plan;
sending the at least one flight plan including the improved flight trajectory to the at least one aircraft; and
validating the improved flight trajectory using an imagery data, when the at least one aircraft flies according to the at least one flight plan including the improved flight trajectory.

Without wishing to be bound by theory, the disclosed method enables regular monitoring of the one or more weather parameters and flight parameters for predicting a contrail formation by a given aircraft and using it to determine and reduce the carbon footprint left by the aforesaid aircraft. Notably, the method enables validating (or verifying) the merits of the aforesaid changes by using images captured by for example the aircraft itself and an additional distant imaging device associated with the aircraft, which capture the images of the contrails at the same time. Based on the improved flight trajectory, a carbon offset value is generated to compensate for the carbon footprint caused by the flight. Beneficially, the method is an efficient, effective, and robust alternative to conventional approaches for mitigating the carbon footprint resulting from contrail formation caused due to increasing air travel volume by changing flight operations and maintenance.

It will be appreciated that variations in incoming solar radiation levels, surface albedo (including contrails), levels of greenhouse gases (for example carbon dioxide (CO₂), methane (CH₄), nitrous oxide (N₂O), ozone (O₃), water vapor, perfluorocarbons (PFCs), hydrofluorocarbons (HFCs), and sulphur hexafluoride (SF₆)), carbon dioxide equivalents, aerosols, clouds, and the like in the atmosphere can all, for instance, alter the energy flux of the atmosphere and an increase in the global carbon footprint.

Typically, contrail (short for condensation trail) refers to white linear clouds appearing from a cruising aircraft's engine emissions. Under favourable atmospheric conditions, contrails result through the condensation of water vapor in the exhaust of cruising aircraft' engines to form ice crystals. Notably, the contrail formation caused by the cruising aircraft is strongly dependent on the local meteorological conditions, the optical properties of the contrail, the spatial coverage of the contrail, as well as the time and season in which they are formed. Contrails are typically generated in a stable atmospheric state having ambient relative humidity close or exceeding saturation (i.e. ice supersaturated humidity >=100%) and temperatures below −40° C. (critical temperature, T_{crit}) Notably, contrails result in a net warming effect during daytime by both reflecting incoming solar radiation and absorbing outgoing longwave radiation, while exclusively having a net warming effect during the night. The width of the contrails may typically vary in a range between 0.1-10 kilometres and can also persist for about 200 kilometres.

Throughout the present disclosure, the term “flight trajectory” as used herein refers to a path (actual or planned) followed by the aircraft to reach a defined destination. Moreover, the term “improved flight trajectory” as used herein refers to the flight trajectory that reduces a likelihood of the contrail formation by the aircraft when one or more of the flight parameters are improved or altered.

The method of the present disclosure comprises receiving one or more weather parameters to determine a contrail forecast data. The one or more weather parameters may be obtained from at least one of: weather monitoring systems, dynamical climate models (for example global climate or regional climate models, such as CMIP5, WRF, UM), atmospheric reanalysis datasets (for example ERAS, GFS), or purely observational datasets (for example satellite measurements). Alternatively, optionally, an ensemble-based probabilistic forecast may be used to determine the contrail forecast data by counting the number of ensemble members which forecast the probability of contrail formation or not. Moreover, vertical simulation profiles of the one or more weather parameters may be generated to calculate the absolute presence and persistence of contrails (i.e. for over 2 minutes). In this regard, the simulation data is stored in 4-dimensional atmospheric datasets of the vertical simulation profiles for querying, i.e. probability of contrail formation at a given latitude, longitude, altitude and time. Optionally, physics-based models (for example Contrail Cirrus Prediction Model (CoCIP)) may be used for predicting when a contrail will form (based on the one or more weather parameters) and how a contrail will evolve.

In an embodiment, the one or more weather parameters is selected from: a temperature, a pressure, a water vapor and ice water content, vapor pressure of air and saturated vapor pressure, wind vectors, number of ice particles in the cloud and corresponding particle size, and incoming and outgoing radiation energy in the atmospheric column. The radiation energy in the atmospheric column includes energy entering, reflected, absorbed and emitted by the Earth system. The energy may be associated with for example the space, the atmosphere, the oceans and geosphere surface of the Earth.

Optionally, the contrail forecast data includes a probability of contrail formation and persistency, and radiation budget. The radiation budget is an account of the balance between the incoming radiations such as energy from the space and the atmosphere, for example solar radiation, and outgoing radiation such as reflected solar radiation or radiation emitted from the Earth system (i.e. the atmosphere, the oceans, and geosphere surface of the Earth). Notably, an imbalance in the radiation budget is responsible for the net warming of the Earth's climate, such as that induced by potential contrail formation.

Moreover, the method comprises receiving one or more flight parameters associated with at least one aircraft to determine a flight data of the at least one aircraft. The one or more flight parameters associated with the at least one aircraft may be obtained from at least one of: an aircraft navigational beacon data (for example Automatic Dependent Surveillance-Broadcast (ADS-B)), engine metric via an original equipment manufacturer (OEM) and airlines. The aircraft navigational beacon data is imported and processed to produce cleaned flight trajectories and schedules corresponding to historical and planned (or future) flights.

In an embodiment, the one or more flight parameters is selected from: a date and time of a flight, a destination, a trajectory, a flight altitude, an expected arrival at the destination, a speed, a latitude for flying the aircraft, a longitude for flying the aircraft, a heading, a payload, an operating characteristic of a particular aircraft type, and a fuel data. The fuel data typically includes a type of fuel, an amount of fuel, a flow rate of fuel, and a combustion time of fuel. Notably, different fuel types have different contrail-forming impacts as a result of particulate emissions (such as black carbon soot) and water vapor (a by-product of the combustion process). In an example, kerosene-based aviation fuel is used predominantly in gas turbine aircraft currently and has a contrail-forming characteristic different from biofuel or hydrogen-based aviation fuel. Moreover, the flight trajectories (historical or planned) and fuel data are combined to produce a flight data for any given aircraft. Furthermore, the flight data is used to query the determined contrail forecast data.

Furthermore, the method comprises receiving a flight schedule comprising at least one flight plan of at least one aircraft, wherein the flight schedule pertains to a given period of time. The term “flight schedule” as used herein refers to a timetable of a series of flights between named airports that are operated in a defined pattern by one or more registered airlines. Notably, the flight schedule provides a list of airlines and their at least one aircraft along with a list of designated destinations, tentative route and the times at which each one is bound to initiate (namely, take-off or departure) and complete (namely, land or arrival). Moreover, the flight schedule may comprise tariffs for services (namely, passenger and/or freight) between named airports at a given period of time (namely, regular and specific times).

The term “flight plan” as used herein refers to a planned route or flight path of a given aircraft. Typically, the flight plan is filed by an operator (such as a pilot) of the given aircraft with an Air Navigation Service Provider (ANSP) prior to departure (or during the flight) of the given aircraft from a named airport. Generally, they flight plan may include basic information such as departure and arrival points and time, estimated time enroute, alternate airports in case of bad weather, type of flight (IFR or VFR), flight levels, the pilot's and crew member's information, number of people on board, information about the aircraft, and so forth.

Furthermore, the method comprises analysing the at least one flight plan to determine at least one navigational avoidance between at least two aircraft. It will be appreciated that analysing at least one flight plan associated with at least one aircraft enables scheduling informed in-air re-routing (and/or landing), namely, rerouting, when two or more aircraft are flying across a same geographical region. Notably, such rerouting may be a change in latitude, longitude or altitude of the flight from an initial flight plan. Beneficially, such rerouting enables navigational avoidance between at least two aircraft. Optionally, the navigational avoidance may encompass collision avoidance, proximity avoidance or similar between two or more aircraft flying in an airspace. Optionally, the navigational avoidance may comprise altering the flight trajectory of at least one of the at least two aircraft. In an example, the navigational avoidance may prevent two aircraft, following the same route, from flying within 1000 to 2000 feet (vertical separation) from each other. In this regard, the step of analysing the at least one flight plan may be implemented using a machine learning-based tool or an artificial intelligence-based tool.

Furthermore, the method comprises determining, based on the contrail forecast data, the flight data and the at least one flight plan, a contrail likelihood associated with the at least one aircraft. The term “contrail likelihood” as used herein refers to a tentative global warming potential for a given aircraft along a tentative flight trajectory. Herein, the contrail likelihood or global warming potential refers to the contribution of contrails (or more specifically carbon dioxide-equivalent emissions from contrails) to the total contribution to global warming. Notably, the contrail forecast data, the flight data and the at least one flight plan provide information about the flight and weather conditions that influence the contrail formation by the at least one aircraft along a tentative flight trajectory. Specifically, the contrail likelihood is determined based on the estimation of contrail formations for the at least one aircraft, particles size in the cloud, carbon and water emissions from the at least one aircraft, and the one or more weather parameters i.e. the existing atmospheric conditions. Optionally, the contrail likelihood is determined per day based on the flight schedule filed with the ANSP operator. Optionally, a fleet-wide per-day forecast modelling may be employed to generate the contrail likelihood associated with the at least one aircraft.

In an exemplary implementation, the contrail likelihood may be determined according to a multi-stage process. In this regard, at a first stage, an initial check may be performed to determine whether the thermodynamic criteria for contrail formation are satisfied. In an embodiment, the initial check may be based on: one or more elements of flight data (e.g. an expected propulsion efficiency of the aircraft, an expected combustion heat of the fuel, and an expected water vapor emission index value), one or more modelled elements of weather data (e.g. a pressure, ambient air temperature and/or water vapor mixing ratio), or a flight location (e.g. latitude, longitude, and elevation). Moreover, at a second stage, if it is determined that the thermodynamic criteria for contrail formation are satisfied, an initial prediction for a contrail may be performed. The initial prediction may include generating a prediction for a location and/or geometry of the contrail, and/or a number, size, habit and/or mass of ice particles in the contrail, based on: one or more elements of flight data (e.g. a mass, a wing geometry, an expected cruise velocity, an expected fuel burn rate, an expected soot emission index value, a flight location), one or more elements of weather data (e.g. an ice saturation mixing ratio, a water vapor mixing ratio, an ice number, an ice particle mass, an ice survival factor), a contrail geometry, and the like. At a third stage, the initial production for the contrail may be evolved over time, based on one or more elements of weather data, for example, modelled air velocities, ice properties and a predicted energy dissipation rate. At a fourth stage, radiative properties of the contrail may be calculated, based on modelled values for outgoing long wave radiation, reflected solar radiation and/or direct solar radiation, to determine the contrail likelihood. At a fifth stage, a final check may be performed to determine if the contrail has dissipated based on the number of ice particles (i.e. below a threshold number (e.g. 1000 m⁻³)), the optical thickness (i.e. below a threshold thickness (e.g. 0.01)), or the contrail mass centre (whether outside an ice super-saturation region (ISSR). If the contrail has not dissipated, the third stage including time evolution of the contrail may be repeated. In this way, the contrail likelihood warming potential may be calculated for a lifetime of the contrail. Alternatively, the contrail likelihood may be calculated for one point in time and extrapolated for the expected length of the flight. Once the contrail is determined to have dissipated, the multi-stage process may be stopped.

Furthermore, the method comprises altering, based on the at least one navigational avoidance and the contrail likelihood, the one or more flight parameters of the at least one aircraft to determine an improved flight trajectory for the at least one flight plan. It will be appreciated that the improved flight trajectory is a flight trajectory different from the tentative flight trajectory. Moreover, the determined improved flight trajectory has an improved contrail likelihood, wherein the improved contrail likelihood is lesser than a tentative contrail likelihood (i.e. a contrail likelihood along a tentative flight trajectory) determined for the tentative flight trajectory. In other words, the flight trajectory with the lowest global warming potential is selected as the improved flight trajectory. The improved contrail likelihood may be calculated in the same way as the tentative contrail likelihood described above, with the necessary input parameters being changed. It will be appreciated that a lower improved contrail likelihood corresponds to a lower probability of contrail formation for a given improved flight trajectory. Therefore, the improved contrail likelihood is associated with a lower global warming potential and thus less atmospheric radiative forcing due to aircraft's carbon dioxide and carbon dioxide equivalent emissions. Moreover, the improved flight trajectory balances lower global warming potential from contrails with potential additional carbon dioxide emissions from extra fuel burn avoiding the contrail formation.

Furthermore, the method comprises sending the at least one flight plan including the improved flight trajectory to the at least one aircraft. In this regard, the at least one aircraft is provided with the improved flight trajectory before take-off or while in-flight. It will be appreciated that by utilising information pertaining to the contrail likelihood as well as by analysing at least one flight plan of the flight schedule, individual aircraft may be re-routed, prior to take-off or while in-flight, for navigational avoidance.

Furthermore, the method comprises validating the improved flight trajectory using an imagery data. Optionally, in this regard, the improved flight trajectory is verified for the improved contrail likelihood (or the minimum global warming potential) thereof by observing the contrail formation (or not) along the improved flight trajectory. The validation of the improved flight trajectory enables determining the merits of altering the one or more flight parameters to determine the improved flight trajectory (i.e. whether or not it was the right decision to re-route the aircraft). Optionally, the step of validation may be performed in real-time, i.e., when the aircraft is in-flight. Alternatively, the the step of validation may be performed after the aircraft has finished the flight (namely, landed). In this regard, validating the improved flight trajectory includes contrail observation along the improved flight trajectory. The contrail formation may be observed from an imagery data from a variety of sources including, but not limited to, imaging devices directly associated with the aircraft, satellite observations, machine learning techniques (for example object imagery and object identification, and so on), and convolutional neural networks. It will be appreciated that the validated data may be used to validate and improve the weather prediction model to determine accurate contrail forecast data for future predictions.

In an embodiment, the step of validating the improved flight trajectory comprises:
capturing, using a first imaging device associated with an aircraft and/or a second imaging device associated with a distant observation system away from the aircraft, at least one contrail image, wherein the at least one contrail image represents actual contrail formation during a flight of the aircraft according to a flight plan having the improved flight trajectory; and
comparing the at least one contrail image with the contrail forecast data to validate the improved flight trajectory of the aircraft for contrail formation at a given time instant.

It will be appreciated that the imagery data may comprise a sequence of images (namely, a sequence of contrail images) captured from the first and/or second imaging device that is/are configured to observe the contrail formation by the aircraft while in-flight (following the tentative or improved flight trajectory). Typically, the first imaging device may be an in-built imaging device in the aircraft or mounted on the aircraft, optionally provided at the end of the aircraft facing away from the aircraft in the direction opposite to the direction of flight (i.e. rear-facing). The first imaging device may be for example a digital imaging system, an infrared imaging devices (for example forward-looking infrared (FLIR) camera, long-wave infrared (LWIR) camera, a medium-wave infrared (MWIR) camera, and the like), night vision imaging system, a lidar (namely, a light-based direction and ranging device), and the like. Moreover, the second imaging device may be a distant observation system configured to observe the aircraft and a vicinity thereof, such as the front as well as rear view of the cruising aircraft up to a pre-defined distance ahead of and behind the aircraft for example. Optionally, the second imaging device may be an in-built imaging device in other aircraft or mounted on the other aircraft to monitor the aircraft causing contrail formation from a side (or behind) thereof. Herein, the other aircraft may serve as a pilot report (PIREP) aircraft that reports information about actual weather conditions and all aircraft in view thereof.

Optionally, the at least one contrail image is obtained from at least one of: an active remote sensing system, a passive remote sensing system, and an in-situ measurement system. The active remote sensing system includes lidar and the like, and the passive remote sensing system includes an earth observation sensor on a satellite (such as the geostationary and/or polar-orbiting satellites) or a camera at the surface of the Earth. The in-situ observation system includes a laser light scattering device on a research aircraft, meteorological radiosondes, a multispectral thermal-infrared imaging spectroradiometer, or an airborne Moderate Resolution Imaging Spectroradiometer (MODIS) simulator, for example. It will be appreciated that the contrails need to be of a predefined size, such as at least 1 kilometre wide, in order to be detected by the distant observation system, such as a satellite. Optionally, the second imaging device may be for example a satellite earth observation (EO) imaging system, a radiosonde-based imaging system, an in-situ data imaging system, and the like. It will be appreciated that a radiosonde is typically used for measuring weather parameters rather than imagery.

The method comprises comparing the at least one contrail image with the contrail forecast data to validate and improve the forecasting models used for forecasting contrail formation and persistence. Moreover, said comparing the at least one contrail image with the contrail forecast data is also used to validate the improved flight trajectory of the aircraft for contrail formation at a given time instant, when the flight is in-flight or after the flight has landed.

In an embodiment, the method further comprises
utilizing the validated improved flight trajectory to generate at least one climatology of an average contrail likelihood over at least one geographical region; and
developing at least one environmentally-friendly flight route using the at least one climatology.

In this regard, the average contrail likelihood over a period of time over a given geographical region enables defining climatology for the given geographical region. Beneficially, such climatology enables altering the one or more flight parameters of the at least one aircraft to minimize the average global warming potential of the aircraft while flying through the given geographical region. In an example, the contrail formation zone is an altitude range having a predefined water vapor content, in the vertical atmospheric column, where the contrails are formed at T_{crit} It will be appreciated that below or above such an altitude range, contrail formation is not observed and thus improved altitude for flying the aircraft may be selected around such an altitude range. Moreover, 4-D maps generated based on the vertical simulation profiles plot contrail formation zones on the given flight trajectory and may guide the pilots to avoid flying into such zones. For example, for a flight from North America to China flying at 36000 feet above the ground, contrails are not observed over countries of the Middle East due to dry and hot weather conditions while contrails are observed in the northern parts of China and United Kingdom. In such example, the altitude for flying the aircraft may be altered from 36000 feet to 32000 feet in areas over northern parts of China and United Kingdom, for example.

Optionally, altering the one or more flight parameters of the at least one aircraft is based on a desired efficiency of re-routing the aircraft and safety aspects. The safety aspects include geo-political safety considerations such as avoiding flying into at least one of: high probability contrail formation zones, warzones, existing weather hazards such as turbulence and thunderstorms, and airports or air space without prior scheduling. In this regard, the process uses an iterative algorithm that calculates the global warming potential associated with altering one or more flight parameters selected from at least one of: the speed of the aircraft, the altitude for flying the aircraft, a latitude for flying the aircraft, a longitude for flying the aircraft, a heading of the aircraft, a time of flight, the amount of fuel carried by the aircraft, or a combination thereof.

In an embodiment, the method further comprises
determining carbon dioxide emissions for a given flight of a given aircraft, based on a flight plan of the given aircraft and a contrail likelihood associated with the given aircraft; and
calculating a carbon dioxide equivalent for the given flight, based on the carbon dioxide emissions, wherein the step of altering one or more flight parameters associated with the given flight is performed in a manner that an improved flight trajectory for the flight plan of the given aircraft minimizes the carbon dioxide equivalent for the given flight.

In this regard, an amount of carbon dioxide (CO₂) gas produced by the fuel burnt by the aircraft is used to determine a corresponding carbon dioxide equivalent for the given aircraft to account for various greenhouse gases produced by the given aircraft. Moreover, CO₂e is also based on the contrail formation during the flight. The global warming potential of the radiative forcing from the contrail is converted to a suitable value (CO₂e) and added to the total global warming potential of the CO₂ emissions. Typically, the carbon dioxide equivalent (CO₂e) is a measure of the global warming potential of the various greenhouse gases (such as methane (CH₄), nitrous oxide (N₂O), hydrofluorocarbons (HFCs), perfluorocarbons (PFCs), sulfur hexafluoride (SF₆), nitrogen trifluoride (NF₃), and so on) including the CO₂, which have the same global warming potential as that of CO₂. Typically, CO₂e is a product of tonnes of a gas and an associated global warming potential thereof. In an example, for 1 million metric tonnes of methane and nitrous oxide, the global warming potentials for which are 25 and 298, respectively, the CO₂e are 25 and 298 million metric tonnes of CO₂ equivalent (MMTCDE). In an example, a given flight of a given aircraft may be releasing 90 kilos of CO₂ per hour, however, the given flight releases other gases resulting in a total CO₂e of 110 kilos of CO₂e per hour, i.e. the other gases added an extra 20 kilos of CO₂e per hour to the atmosphere. In this regard, one or more flight parameters associated with the given flight may be altering to minimizes the CO₂e for the given flight. It will be appreciated that by following the improved flight trajectory the contrail formation is reduced and therefore the CO₂e is reduced for that flight. Therefore, beneficially, the disclosed method reduces the overall global warming potential associated with the flight.

Moreover, the minimization of the contrail likelihood using suitable changes (namely, altering) to the one or more flight parameters associated with the given flight is performed in a manner that an improved flight trajectory for the flight plan of the given aircraft determines a total saving in the carbon dioxide equivalent for the improved flight trajectory, wherein the total saving in the carbon dioxide equivalent is a difference between the tentative carbon likelihood and the improved carbon likelihood. Beneficially, the total saving in the carbon dioxide equivalent for the improved flight trajectory corresponds to the avoidance of contrail formation when flying through the improved flight trajectory. Additionally, the total saving in the carbon dioxide equivalent is quantified for a given flight, or a collection of flights, both historically and for planned (or future) flights. Beneficially, minimization of the contrail likelihood may also be associated with a potential minimization of flight cost by also including carbon offset fees in the process. Thereby, promoting the flights associated with such airlines both environmentally-friendly (namely, carbon-neutral label) as well as cost effective for the passengers.

Typically, total saving in the global warming potential is reported in a variety of ways including through mandatory or voluntary disclosure regimes. Notably, the disclosure regimes are determined by a company and/or a country of the location of the company. In an exemplary implementation, the global warming potential may be reported in annual reports of the company or through international obligations such as the Paris Agreement. In an alternate exemplary implementation, the global warming potential may be incorporated into the carbon offset schemes, such as regional and international emissions trading schemes, for example the Carbon Offsetting and Reduction Scheme for International Aviation (CORSIA). In such case, the global warming potential may be converted to a suitable carbon offset value.

In an embodiment, the minimization of the contrail likelihood is associated with increase in a carbon offset value, and wherein the carbon offset value is associated with a fuel utilized for a given flight. It will be appreciated that the carbon offset value is proportional to the emission of CO₂ gas and other CO₂e generated by human activities, in the present case, aviation. In the above example, the CO₂ gas and other CO₂e are generated as a result for burning of fuel of the aircraft. Therefore, in such case, the fuel of the aircraft may be changed from 100% kerosene-based aviation fuel to a 60% kerosene-based aviation fuel and 40% biofuel, for example, to minimize the CO₂ gas and other CO₂e for the given flight.

Moreover, a suitable carbon offset value is generated for a corresponding at least one parameter associated with the net global warming potential. In an example, for carbon dioxide, a carbon offset value is generated. In such an example, if in the year 2018, the impact on global warming from aviation is 1.834×10⁹ tonnes of carbon dioxide and/or carbon dioxide equivalent, the result is a loss of 1 billion tonnes of carbon dioxide equivalent from the climate by avoiding 50% of contrail formation, through contrail forecasting and flight changes. Then, for this example, at a carbon price of $10/tonnes, the net global warming potential equates to a carbon offset market value of around $10 billion per annum.

Typically, technological interventions may be conducted to minimize the emission of CO₂ gas and other CO₂e as well as to reduce the overall global warming potential associated therewith. Optionally, the technological interventions may typically include investment in projects elsewhere which represent a reduction in the emissions of the CO₂ gas and other CO₂e. Such projects may include, for example, renewable energy-based projects (for example, wind power, solar power, hydroelectric power, biofuel, and the like), methane collection and combustion systems, energy efficient models, tree-planting projects, and the like. Notably, the carbon offset values are carbon offset credits for trade between carbon offset vendors (such as parties under various environmental and trade organizations, such as for example, the Kyoto Protocol, EU Emission Trading Scheme) and buyers (such as individuals, companies, governments, or other entities). Moreover, the carbon offset vendors may be organizations that voluntarily offset their contrail likelihood with an aim of promoting sustainability. The buyers of the carbon offset value may be companies that emit various greenhouse gases as a by-product of their business. Such companies are required to either cut their emissions or buy carbon offset values in lieu thereof.

In an embodiment, the method further comprises assessing a fuel burn penalty or fuel savings achieved, based on the fuel utilized for the given flight. The fuel burn penalty and the fuel savings are associated with the tentative flight trajectory and improved flight trajectory, respectively. Herein, the tentative flight trajectory may result in a higher fuel consumption (burning), thereby increasing the contrail likelihood associated with a given flight; while the improved flight trajectory may result in a lower fuel consumption (burning), thereby minimizing the contrail likelihood associated with a given flight. Optionally, in an embodiment, the improved flight trajectory may burn more fuel and therefore has higher CO₂ emission, but the improved flight trajectory is configured to reduce CO₂e from contrails by more, so that the overall improved flight trajectory reduces total CO₂e. Optionally, the fuel burn penalty or fuel savings achieved may also be associated with the carbon offset value, wherein the fuel burn penalty is incurred for a decrease in the carbon offset value and the fuel saving is achieved for an increase in the carbon offset value.

In this regard, optionally, the method may comprise changing maintenance activity for an engine of the aircraft based on the contrail likelihood of a given flight of an aircraft, and wherein the improvement of maintenance activity for the engine comprises:
receiving a data associated with the engine of the aircraft;
generating an engine simulation model based on the received data for predicting a condition of the engine of the aircraft; and
determining a maintenance activity to be performed on the engine based on the predicted condition of the engine.

Optionally, in this regard, the maintenance activity for the engine of the aircraft is determined to enable an improved efficiency of combustion of the fuel in the engine and reduced emission of carbon dioxide or carbon dioxide equivalents from the exhaust of the aircraft. The data associated with the engine of the aircraft may include a type of engine, an age of the engine, an information about the OEM, a type of fuel, an amount of fuel carried by the engine, a flow rate of fuel, and a combustion time of fuel, a last clean-up information for the engine, a chemical analysis of the debris in the exhaust of the engine, and so on. The data associated with the engine of the aircraft is used to predict a present condition of the engine of the aircraft, such as amount of soot in the exhaust, nature of corrosion, amount of damage, and so on. The maintenance activity includes, but is not limited to, a change in fuel (for example shifting to green aviation fuels, such as biofuels, or hydrogen-based aviation fuels), removal of soot particles from the exhaust by proper cleaning thereof, adapting to an improved engine design, and so forth.

In an embodiment, the method further comprises executing an electronic flight bag (EFB) software on an EFB device to support in-air tactical response. Typically, an EFB is an electronic display system for flight-deck use such as for displaying data or performing calculations thereon. Optionally, the EFB device may be a portable (hand-held device) or an installed equipment typically mounted on the aircraft control panel. Notably, the EFB software on an EFB device enables generating an efficient in-air tactical response as well as efficient flight management both before and after the flight. In an example, the EFB software may assist in recording the change in flight trajectories and causal parameters (e.g. bad weather conditions, prohibited zones, high contrail zones, and the like) invoking change in flight trajectories at various instances, and share such recording with an airline or an ANSP operator. Optionally, the interface of the EFB device may enable real-time re-routing of the one or more aircraft as per the flight management data recorded and shared thereby with the airline or an ANSP operator.

In an embodiment, the method further comprises executing an air navigation service provider (ANSP) software for enabling at least one air navigation task to be performed. Typically, the ANSP software enables generating an efficient in-air tactical response as well as efficient flight management both before and after the flight, similar to the EFB software. Additionally, the ANSP software enables strategic diversions as at least one flight plan is filed. The ANSP software offers improved flight trajectories to the ANSP operator as well as the flight operator (or pilot) to execute improved flight trajectories. Moreover, the ANSP software offers tracking CO₂ and CO₂e emissions, NOx and soot from contrails. Furthermore, the ANSP software offers performing emissions accounting for MRV schemes such as CORSIA.

In an embodiment, the method further comprises providing, on an interactive user interface of a display device, at least one of: the one or more weather parameters, the contrail forecast data, the one or more flight parameters, the flight data, the flight schedule, the contrail likelihood, the improved flight trajectory, the imagery data, a validated improved flight trajectory, at least one environmentally-friendly flight route, a carbon dioxide equivalent, a carbon offset value, a fuel burn penalty or fuel savings achieved. The interactive user interface of the display device enables receiving input from the user of the user device and displaying as an output data corresponding to the received input. Optionally, the display device may be selected from at least one of: the EFB device, a device in the cockpit, a portable device handled by a pilot of the aircraft. It will be appreciated that the aforementioned list of data displayed on the interactive user interface of the display device is a non-exhaustive list and may include other data such as a map of the city being flown over, a current weather condition of the said city, an air traffic over alternate airports enroute, an air traffic over the destination airport, and so forth. Beneficially, displaying information corresponding to the carbon offset value and sharing the same with the onboard passengers may encourage choosing the same airline for future travel by the passengers.

A second aspect of the invention provides a system for determining an improved flight trajectory, the system comprising a processor, wherein the processor is configured to:
receive one or more weather parameters to determine a contrail forecast data;
receive one or more flight parameters associated with at least one aircraft to determine a flight data of the at least one aircraft;
receive a flight schedule comprising at least one flight plan of at least one aircraft, wherein the flight schedule pertains to a given period of time;
analyze the at least one flight plan to determine at least one navigational avoidance between at least two aircraft;
determine, based on the contrail forecast data, the flight data and the at least one flight plan, a contrail likelihood associated with the at least one aircraft;
alter, based on the at least one navigational avoidance and the contrail likelihood, the one or more flight parameters of the at least one aircraft to determine an improved flight trajectory for the at least one flight plan;
send the at least one flight plan including the improved flight trajectory to the at least one aircraft; and
validate the improved flight trajectory using an imagery data, when the at least one aircraft flies according to the at least one flight plan including the improved flight trajectory.

Optionally, the processor comprises various modules like a weather prediction module, a trajectory module, an engine module, a contrail likelihood forecasting module, an optimization module, a validation module, and a carbon offset module. The processor is configured to receive one or more weather parameters using the weather prediction module to determine the contrail forecast data. Moreover, the contrail forecast data is provided as an output of the weather prediction module. The processor is configured to receive one or more flight parameters associated with at least one aircraft to determine the flight data of the at least one aircraft using the trajectory and engine modules. The processor is configured to receive a flight schedule comprising at least one flight plan of at least one aircraft, from the trajectory module, to analyse the at least one flight plan to determine at least one navigational avoidance between at least two aircraft. The processor is configured to determine, based on the contrail forecast data, the flight data and the at least one flight plan, a contrail likelihood associated with the at least one aircraft using the contrail likelihood forecasting module. The processor is configured to alter, based on the at least one navigational avoidance and the contrail likelihood, the one or more flight parameters of the at least one aircraft, using the optimization module, to determine an improved flight trajectory for the at least one flight plan. The processor is configured to send the at least one flight plan including the improved flight trajectory to the at least one aircraft. The processor is configured to validate the improved flight trajectory using the imagery data obtained by the validation module.

In an embodiment, the system further comprises a first imaging device associated with an aircraft and/or a second imaging device associated with a distant observation system away from the aircraft, wherein the first imaging device and/or a second imaging device is/are configured to capture at least one contrail image, wherein the at least one contrail image represents actual contrail formation during a flight of the aircraft according to a flight plan having the improved flight trajectory, wherein the processor is configured to compare the at least one contrail image with the contrail forecast data to validate the improved flight trajectory of the aircraft for contrail formation at a given time instant.

In an embodiment, the at least one contrail image is obtained from at least one of: an active remote sensing system, a passive remote sensing system, and an in-situ measurement system. Notably, the active remote sensing system, the passive remote sensing system, and the in-situ measurement system are examples of the second imaging device.

In some embodiments, the system described above may be implemented as part of a system including an airline operator and/or an air navigation server provider (ANSP). For example, receiving one or more flight parameters associated with the aircraft to determine a flight data may include requesting one or more flight plans from the airline operator and/or ANSP.

In some examples, the airline operator may have previously signed an agreement with an operator of the system, e.g. a contrail offset project agreement.

The airline operator may generate the flight plan based on one or more flight parameters substantially as described above. For example, the flight plan may be generated based on: a date and time of a flight, a destination, a trajectory, a flight altitude, an expected arrival at the destination, a speed, a latitude for flying the aircraft, a longitude for flying the aircraft, a heading, a payload, an operating characteristic of a particular aircraft type, and a fuel data. The flight plan may be generated by a flight planning software (FPS). In some examples, the airline operator may submit the generated flight plan to the ANPS. The generated flight plan may be referred to as an initial, provisional or baseline flight plan.

The generated flight plan may also be referred to as the tentative flight trajectory or may include the tentative flight trajectory. The system may determine tentative contrail likelihood, along the tentative flight trajectory and alter the one or more flight parameters to determine an improved flight trajectory having an improved contrail likelihood.

In some examples, the system may send or otherwise provide the improved flight trajectory to the airline operator and/or the ANSP. The airline operator may generate a revised flight plan based to improved flight trajectory. For example, the airline operator may use the FPS to generate the revised plan using the improved flight trajectory as an additional input. The airline operator may submit the revised flight plan to the ANSP.

In some examples, the airline operator may perform a flight according to the revised flight plan. That is, the airline operator may fly an aircraft along the improved flight trajectory. In some examples, new flight data may be available during flight, e.g., current or up-to-date weather data. New data may be made available to the airline operator, a pilot of the aircraft and/or the ANSP, for example, via an internet-connector device or application (e.g., an electronic flight bag), or via an air traffic control service. Any of the airline operator, pilot and/or ANSP may have opportunity to change the flight trajectory, based on the new flight data.

As described above, the system may be configured to validate the improved flight trajectory using an imagery data, e.g. based on the flight performed, and may determine an atmospheric radiative forcing difference between the initial flight plan and the revised flight plan.

In some examples, as described above, the atmospheric radiative forcing difference may be incorporated into an offset scheme, such as the Carbon Offsetting and Reduction Scheme for International Aviation (CORSIA). In such case, the net contrail likelihood may be converted to a suitable carbon offset value such as carbon dioxide equivalent (CO₂e) units. Such units may be carbon offset value against emissions e.g. to meet regulatory requirements, and/or traded for monetary value. In some examples, the carbon offset value may be allocated to the airline operator and/or the operator of the system.

A third aspect of the invention provides a computer program product for determining an improved flight trajectory, the computer program product comprising a non-transitory machine-readable data storage medium having stored thereon program instructions that, when accessed by a processor, cause the processor to carry out the method of the first aspect.

Optionally, the computer program product is implemented as an algorithm, embedded in a software stored in the non-transitory machine-readable data storage medium. The non-transitory machine-readable data storage medium may include, but is not limited to, an electronic storage device, a magnetic storage device, an optical storage device, an electromagnetic storage device, a semiconductor storage device, or any suitable combination of the foregoing. Examples of implementation of the computer-readable medium include, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory.

In this regard, the algorithm quantifies the climate impact caused by an aircraft and changes an aircraft flight plan or in-flight trajectory to prevent contrail formation by using the aforementioned methods.

Optionally, the program instructions cause the processor to:
receive one or more weather parameters to determine a contrail forecast data;
receive one or more flight parameters associated with at least one aircraft to determine a flight data of the at least one aircraft;
receive a flight schedule comprising at least one flight plan of at least one aircraft, wherein the flight schedule pertains to a given period of time;
analyse the at least one flight plan to determine at least one navigational avoidance between at least two aircraft;
determine, based on the contrail forecast data, the flight data and the at least one flight plan, a contrail likelihood associated with the at least one aircraft;
alter, based on the at least one navigational avoidance and the contrail likelihood, the one or more flight parameters of the at least one aircraft to determine an improved flight trajectory for the at least one flight plan;
send the at least one flight plan including the improved flight trajectory to the at least one aircraft; and
validate the improved flight trajectory using an imagery data, when the at least one aircraft flies according to the at least one flight plan including the improved flight trajectory.

Optionally, the program instructions cause the processor to compare the at least one contrail image, captured using the first imaging device associated with the aircraft and/or the second imaging device associated with a distant observation system away from the aircraft, with the contrail forecast data to validate the improved flight trajectory of the aircraft for contrail formation at a given time instant and wherein the at least one contrail images comprise multiple images of the contrail taken continuously when the aircraft is in flight and collectively constitute the imagery data.

Embodiments of the present disclosure substantially eliminate, or at least partially address, the aforementioned problems in the prior art, and enable providing an improved flight trajectory that beneficially mitigates contrail formation and their resultant effect on the climate (namely, climate impact). In this regard, the disclosed method changes one or more flight parameters, such as a flight plan (including trajectory, fuel data, and so on) associated with the aircraft. Moreover, such changes may be validated to improve the prediction models to predict the probability of contrail formation for the aforesaid aircraft for a given flight plan before the take-off of the flight as well as during the flight. Moreover, the climate impact caused by the contrail formation is compensated by an offset value, generated based on the aforementioned changes, corresponding to the amount of carbon and non-carbon equivalents generated by a given flight.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Improved features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the accompanying drawings, in which:

FIG. 1 is a flowchart illustrating steps of a method for determining an improved flight trajectory, in accordance with an embodiment of the present disclosure; and

FIG. 2 is a schematic illustration of a system for determining an improved flight trajectory, in accordance with an embodiment of the present disclosure.

### DETAILED DESCRIPTION

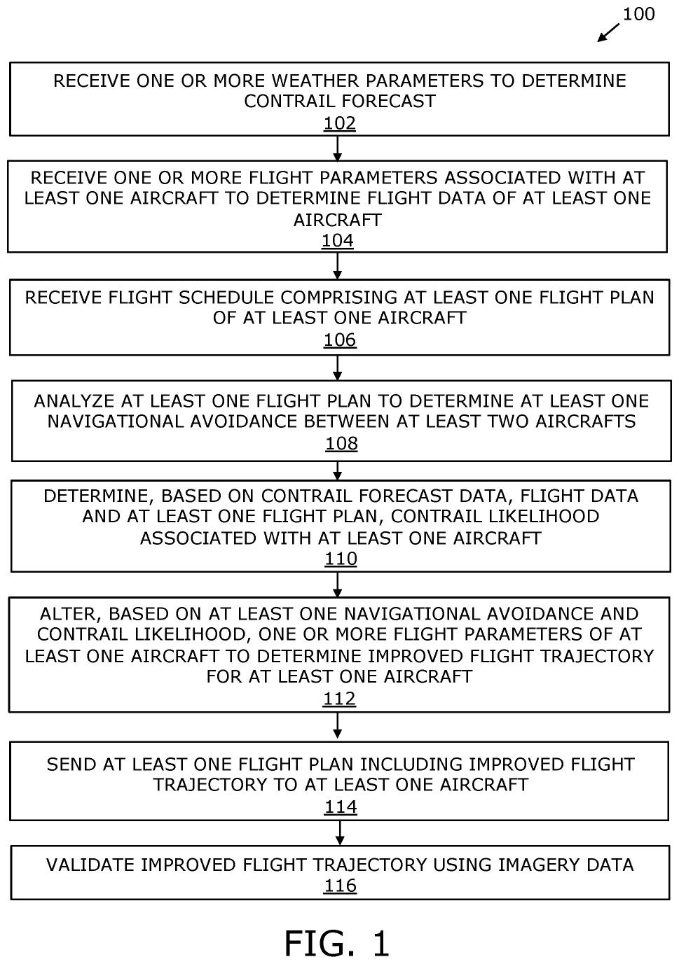

Referring to FIG. 1, a flowchart is shown illustrating steps of a method for determining an improved flight trajectory, in accordance with an embodiment of the present disclosure. At a step 102, one or more weather parameters are received to determine a contrail forecast data. At a step 104, one or more flight parameters associated with at least one aircraft are received to determine a flight data of the at least one aircraft. At a step 106, a flight schedule comprising at least one flight plan of at least one aircraft is received, wherein the flight schedule pertains to a given period of time. At a step 108, the at least one flight plan is analyzed to determine at least one navigational avoidance between at least two aircraft. At a step 110, a contrail likelihood associated with the at least one aircraft is determined based on the contrail forecast data, the flight data and the at least one flight plan. At a step 112, the one or more flight parameters of the at least one aircraft are altered, based on the at least one navigational avoidance and the contrail likelihood, to determine an improved flight trajectory for the at least one flight plan. At a step 114, the at least one flight plan including the improved flight trajectory is sent to the at least one aircraft. At a step 116, the improved flight trajectory is validating using an imagery data, when the at least one aircraft flies according to the at least one flight plan including the improved flight trajectory.

The steps 102, 104, 106, 108, 110, 112, 114 and 116 are only illustrative and other alternatives can also be provided where one or more steps are added, one or more steps are removed, or one or more steps are provided in a different sequence without departing from the scope of the claims herein.

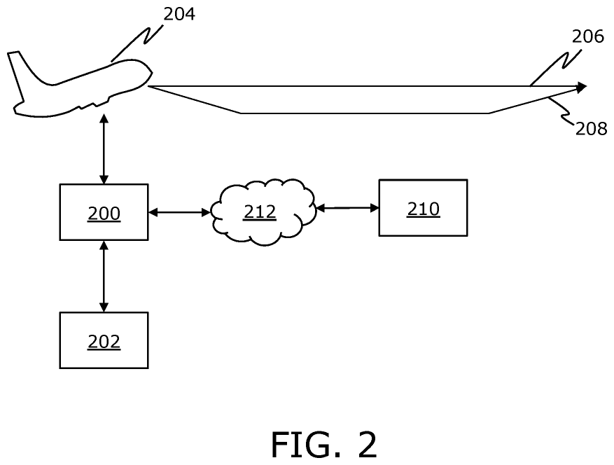

Referring to FIG. 2, there is illustrated a system 200 for determining an improved flight trajectory 208, in accordance with an embodiment of the present disclosure. The system 200 comprises a processor. The processor of the system 200 is coupled to a weather monitoring system 202 and the aircraft 204. The processor is configured to:
receive one or more weather parameters, from the weather monitoring system 202, to determine a contrail forecast data;
receive one or more flight parameters associated with at least one aircraft 204 to determine a flight data of the at least one aircraft 204;
receive a flight schedule comprising at least one flight plan 206 of at least one aircraft 204, wherein the flight schedule pertains to a given period of time;
analyze the at least one flight plan to determine at least one navigational avoidance between at least two aircraft;
determine, based on the contrail forecast data, the flight data and the at least one flight plan, a contrail likelihood associated with the at least one aircraft 204;
alter, based on the at least one navigational avoidance and the contrail likelihood, the one or more flight parameters of the at least one aircraft to determine an improved flight trajectory 208 for the at least one flight plan 206;
send the at least one flight plan including the improved flight trajectory 208 to the at least one aircraft 204; and
validate the improved flight trajectory 208 using an imagery data, such as from a distant observation system 210 away from the aircraft 204, when the at least one aircraft 204 flies according to the at least one flight plan 206 including the improved flight trajectory 208.

The processor is communicably coupled to the distant observation system 210 via a communication network 212.

1. A method for determining an improved flight trajectory, the method comprising:
receiving one or more weather parameters to determine a contrail forecast data;
receiving one or more flight parameters associated with at least one aircraft to determine a flight data of the at least one aircraft;
receiving a flight schedule comprising at least one flight plan of at least one aircraft, wherein the flight schedule pertains to a given period of time;
analyzing the at least one flight plan to determine at least one navigational avoidance between at least two aircraft;
determining, based on the contrail forecast data, the flight data and the at least one flight plan, a contrail likelihood associated with the at least one aircraft;
altering, based on the at least one navigational avoidance and the contrail likelihood, the one or more flight parameters of the at least one aircraft to determine an improved flight trajectory for the at least one flight plan;
sending the at least one flight plan including the improved flight trajectory to the at least one aircraft; and
validating the improved flight trajectory using an imagery data, when the at least one aircraft flies according to the at least one flight plan including the improved flight trajectory.

2. A method according to claim 1, further comprising:
utilizing the validated improved flight trajectory to generate at least one climatology of an average contrail likelihood over at least one geographical region; and
developing at least one environmentally-friendly flight route using the at least one climatology.

3. A method according to claim 1, further comprising:
determining carbon dioxide emissions for a given flight of a given aircraft, based on a flight plan of the given aircraft and a contrail likelihood associated with the given aircraft; and
calculating a carbon dioxide equivalent for the given flight, based on the carbon dioxide emissions, wherein the step of altering one or more flight parameters associated with the given flight is performed in a manner that an improved flight trajectory for the flight plan of the given aircraft minimizes the carbon dioxide equivalent for the given flight.

4. A method according to claim 1, wherein the minimization of the contrail likelihood is associated with increase in a carbon offset value, and wherein the carbon offset value is associated with a fuel utilized for a given flight.

5. A method according to claim 4, further comprising assessing a fuel burn penalty or fuel savings achieved, based on the fuel utilized for the given flight.

6. A method according to claim 1, wherein the step of validating the improved flight trajectory using the imagery data comprises:
capturing, using a first imaging device associated with an aircraft and/or a second imaging device associated with a distant observation system away from the aircraft, at least one contrail image, wherein the at least one contrail image represents actual contrail formation during a flight of the aircraft according to a flight plan having the improved flight trajectory; and
comparing the at least one contrail image with the contrail forecast data to validate the improved flight trajectory of the aircraft for contrail formation at a given time instant.

7. A method according to claim 1, further comprising executing an electronic flight bag (EFB) software on an EFB device to support in-air tactical response.

8. A method according to claim 1, further comprising executing an air navigation service provider (ANSP) software for enabling at least one air navigation task to be performed.

9. A method according to claim 1, further comprising providing, on an interactive user interface of a display device, at least one of: the one or more weather parameters, the contrail forecast data, the one or more flight parameters, the flight data, the flight schedule, the contrail likelihood, the improved flight trajectory, the imagery data, a validated improved flight trajectory, at least one environmentally-friendly flight route, a carbon dioxide equivalent, a carbon offset value, a fuel burn penalty or fuel savings achieved.

10. A method according to claim 1, wherein the one or more weather parameters is selected from: a temperature, a pressure, a water vapor and ice water content, vapor pressure of air and saturated vapor pressure, wind vectors, number of ice particles in the cloud and corresponding particle size, and incoming and outgoing radiation energy in the atmospheric column.

11. A method according to claim 1, wherein the one or more flight parameters is selected from: a date and time of a flight, a destination, a trajectory, a flight altitude, an expected arrival at the destination, a speed, a latitude for flying the aircraft, a longitude for flying the aircraft, a heading, a payload, an operating characteristic of a particular aircraft type, and a fuel data.

12. A system for determining an improved flight trajectory, the system comprising a processor, wherein the processor is configured to:
receive one or more weather parameters to determine a contrail forecast data;
receive one or more flight parameters associated with at least one aircraft to determine a flight data of the at least one aircraft;
receive a flight schedule comprising at least one flight plan of at least one aircraft, wherein the flight schedule pertains to a given period of time;
analyze the at least one flight plan to determine at least one navigational avoidance between at least two aircraft;
determine, based on the contrail forecast data, the flight data and the at least one flight plan, a contrail likelihood associated with the at least one aircraft;
alter, based on the at least one navigational avoidance and the contrail likelihood, the one or more flight parameters of the at least one aircraft to determine an improved flight trajectory for the at least one flight plan;
send the at least one flight plan including the improved flight trajectory to the at least one aircraft; and
validate the improved flight trajectory using an imagery data, when the at least one aircraft flies according to the at least one flight plan including the improved flight trajectory.

13. A system according to claim 12, further comprising a first imaging device associated with an aircraft and/or a second imaging device associated with a distant observation system away from the aircraft, wherein the first imaging device and/or the second imaging device is/are configured to capture at least one contrail image, wherein the at least one contrail image represents actual contrail formation during a flight of the aircraft according to a flight plan having the improved flight trajectory, wherein the processor is configured to compare the at least one contrail image with the contrail forecast data to validate the improved flight trajectory of the aircraft for contrail formation at a given time instant.

14. The system according to claim 13, wherein the at least one contrail image is obtained from at least one of: an active remote sensing system, a passive remote sensing system, and an in-situ measurement system.

15. A computer program product for determining an improved flight trajectory, the computer program product comprising a non-transitory machine-readable data storage medium having stored thereon program instructions that, when accessed by a processor, cause the processor to execute steps of the method of claim 1.
